(19) United States
(12) Patent Application Publication
(10) Pub. No.: US 2023/0032971 A1
(43) Pub. Date: Feb. 2, 2023

(54) ELECTRIC DRIVE SYSTEM FOR A VEHICLE

(71) Applicants: Transportation IP Holdings, LLC, Norwalk, CT (US); Komatsu America Corp., Chicago, IL (US); Cummins Inc., Columbus, IN (US)

(72) Inventors: Henry Todd Young, Erie, PA (US); Rekha Doddarangaiah Prasad, Warrendale, PA (US); Timothy Brown, Erie, PA (US); David John Scott, Washington, IL (US); Paul Wiczynski, Columbus, IN (US); Phanindra Garimella, Bloomington, IN (US)

(21) Appl. No.: 17/876,267

(22) Filed: Jul. 28, 2022

Related U.S. Application Data
(60) Provisional application No. 63/228,444, filed on Aug. 2, 2021.

(51) Int. Cl. B60K 28/10; B60T 17/22

(52) U.S. Cl. CPC B60K 28/10; B60T 17/22; B60Y 2300/18

(57) ABSTRACT

A method includes monitoring one or more of an ambient condition or an operational condition of a vehicle system while the vehicle system is stationary and a propulsion system of the vehicle system is operating at an idle speed, determining whether the one or more of the ambient condition or the operational condition satisfy one or more reduced auxiliary or parasitic load criteria, reducing one or more of an auxiliary load or a parasitic load responsive to determining that the one or more ambient condition or the operational condition satisfy the one or more reduced auxiliary or parasitic load criteria, and subsequently reducing the idle speed at which the propulsion system is operating to a slower speed following reducing the one or more of the auxiliary load or the parasitic load.

### CROSS-REFERENCE TO RELATED APPLICATIONS

This application claims priority to U.S. Provisional Application No. 63/228,444 (filed 02-August-2021), the entire disclosure of which is incorporated herein by reference.

### BACKGROUND

### Technical Field

The subject matter described herein relates to a propulsion system including an electric drive system and associated method.

### Discussion of Art

Many alternators can operate at a variety of speeds to generate different amounts of power. When increased power is demanded (due to increased loads placed on the system), the alternator can be operated at faster speeds. When decreased power is demanded, the alternator can be operated at slower speeds. At idle, the alternator can generate enough power to stay on or activated and operate auxiliary loads (e.g., coolant pumps, alternators, etc.), but not enough to perform useful work, such as propelling the vehicle. It may be possible to change the amount of voltage or current by manipulating the electric field in the alternator while maintaining a constant rotational speed. It may be desirable to have a system and method that differs from those that are currently available.

### BRIEF DESCRIPTION

In one embodiment, a method is provided and includes monitoring one or more of an ambient condition or an operational condition of a vehicle system while the vehicle system is stationary and a propulsion system of the vehicle system is operating at an idle speed, determining whether the one or more of the ambient condition or the operational condition satisfy one or more reduced auxiliary or parasitic load criteria, reducing one or more of an auxiliary load or a parasitic load responsive to determining that the one or more ambient condition or the operational condition satisfy the one or more reduced auxiliary or parasitic load criteria, and subsequently reducing the idle speed at which the propulsion system is operating to a slower speed following reducing the one or more of the auxiliary load or the parasitic load.

In one embodiment, a vehicle control system includes a controller having one or more processors that may monitor one or both of an ambient condition and an operational condition of a vehicle system while the propulsion system of the vehicle system is operating in a first mode at a first idle speed. The one or more processors may determine whether the one or more of the ambient condition or the operational condition satisfy one or more reduced idle speed criteria. The one or more processors may switch the propulsion system to operate in a second mode at a relatively slower second idle speed responsive to the one or more of the ambient condition or the operational condition satisfying the one or more reduced idle speed criteria.

In one embodiment, a method includes monitoring one or more of an ambient condition or an operational condition of a vehicle system while a propulsion system of the vehicle system is operating at an idle speed, determining whether the one or more of the ambient condition or the operational condition satisfy one or more reduced idle speed criteria, reducing the idle speed at which the propulsion system is operating to a slower speed responsive to the one or more of the ambient condition or the operational condition satisfying the one or more reduced idle speed criteria, monitoring one or more of the operational condition of the vehicle system or an operational load placed on the propulsion system of the vehicle system while the vehicle system remains stationary, and increasing the idle speed of the propulsion system responsive to one or more of the operational condition of the vehicle system changing or the operational load placed on the propulsion system increasing.

### BRIEF DESCRIPTION OF THE DRAWINGS

The inventive subject matter may be understood from reading the following description of non-limiting embodiments, with reference to the attached drawings, wherein below:

FIG. 1 illustrates one example of an electric drive system; and

FIG. 2 illustrates a flowchart of one example of a method for controlling an electric drive system of a powered system.

### DETAILED DESCRIPTION

Embodiments of the subject matter described herein relate to a propulsion system for a vehicle. The propulsion system may include an electric drive system having an engine, one or more motors, an alternator, and a controller. The contemplated method may reduce speeds at idle to increase efficiency of the system. In one embodiment, the systems and methods contemplated herein may reduce the idle speeds of a diesel electric haul truck used in mines and other applications. Alternatively, the systems and methods may reduce the idle speeds of other vehicles, such as buses, automobiles, agricultural vehicles, rail vehicles, or the like.

Embodiments of the inventive subject matter may include systems and methods that control the alternator output so that the system speed may be set at a lower idle speed and/or to a fuel efficient operating point to reduce fuel consumption. This may be based, at least in part, on allowable logic conditions for a determined amount of time. This speed reduction may reduce parasitic loads on the system. For example, the mode of electric drive controls can be switched to a lower power consumption mode, thereby reducing hydraulic loads, pump loads, and other possible parasitic loads to lower power consumption modes. Further, the system speed can be modified to meet the demands of the powered system in which the engine is disposed. In one example, the controller may operate an engine at a speed that is slower than idle, and it can be controlled or varied based at least in part on hydraulic pump load, heating/cooling for operator comfort, and the like. In another example, the system can be re-adjusted or increased to improve cooling capacity when thermal restrictions apply.

Embodiments within the system and method may monitor various system parameters such as ambient temperature, parking brake state, wheel brake lock state, operational history, etc., and determine when the conditions (indicated by the parameters) allow for switching the operation to a relatively reduced system speed (e.g., that is slower than an idle speed). The system and method then control the drive system to reduce loads on the drive system. For example, the system and method can reduce the link voltage, reduce parasitic loads (e.g., loads that do not propel the vehicle, such as blower speeds), or otherwise reduce the load on the drive system. Once these loads are reduced, the idle speed of the vehicle can be reduced to cause the drive system to operate at a reduced idle speed. The engine can operate at the reduced idle speed unless or until the parasitic loads increase and/or the drive system speed needs to increase to perform other work (e.g., propel the vehicle). For example, if a heating or cooling system is activated (or the load from this system changes), the system and method can increase the output of the alternator, and subsequently the speed of the engine to meet this additional load. As another example, if a throttle is engaged to propel the vehicle the system and method can increase the output of the alternator, and subsequently the speed of the engine, to meet the anticipated load.

In one embodiment, the system may have a local data collection system deployed that may use machine learning to enable derivation-based learning outcomes. The system may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the system may include a policy engine that may apply one or more policies. These policies may be based at least in part on characteristics of a given item of equipment or environment. With respect to control policies, a neural network can receive input of a number of environmental and task-related parameters. These parameters may include an identification of a determined trip plan for a vehicle group, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes the vehicle to operate. This may be accomplished via backpropagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

The system can use this artificial intelligence or machine learning to receive input (e.g., one or more system parameters), use a model that associates system parameters with different reduced engine speeds at idle to select a reduced engine speed, and then provide an output (e.g., the reduced engine speed at idle that was selected using the model). The system may receive additional input of the change in the engine speed that was selected, such as analysis of fuel or energy consumption, operator input, or the like, that indicates whether the machine-selected operating mode provided a desirable outcome or not. Based on this additional input, the system can change the model, such as by changing the engine speed at idle when a similar or identical system parameter is received the next time or iteration. The system can then use the changed or updated model again to select a reduced engine speed, receive feedback on the selected engine speed, change or update the model again, etc., in additional iterations to repeatedly improve or change the model using artificial intelligence or machine learning.

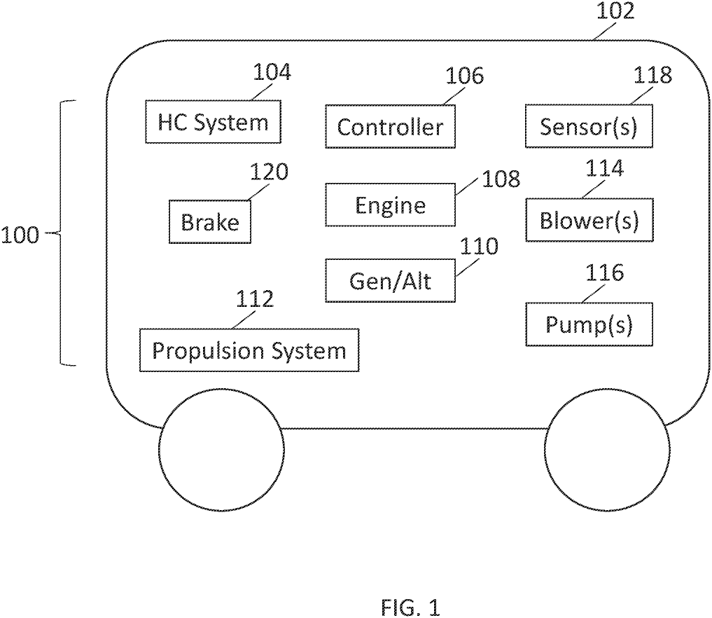

FIG. 1 illustrates one example of an electric drive system 100. The drive system is shown onboard a powered system 102, such as a mining vehicle. The drive system includes a controller 106. The controller represents hardware circuitry having and/or connected with one or more processors, such as one or more microprocessors, field programmable gate arrays, integrated circuits, and/or the like. The controller optionally can represent an engine control unit. The controller communicates with an engine 108 of the powered system. This engine can be a fuel-consuming engine, such as a diesel engine. Not all embodiments of the inventive subject matter, however, are limited to diesel engines. The engine can represent another type of engine that consumes fuel other than diesel fuel.

The engine consumes fuel to perform work, such as rotating a shaft joined to a generator or alternator 110 (“Gen/Alt” in FIG. 1), which causes the generator or alternator to output electric current (e.g., a link voltage). This current can be stored or provided to one or more powered components of the powered system, such as a propulsion system 112 and/or auxiliary or parasitic loads. The propulsion system can include one or more motors that propel the powered system (e.g., traction motors) using electric current output by the generator or alternator. The auxiliary or parasitic loads represent components that are powered by current created by way of operation of the engine and that perform work, but that do not perform work to propel the vehicle. For example, an auxiliary or parasitic load can come from a heating/cooling system 104 that includes one or more heaters (e.g., electric powered heating elements), or from such appliances as air conditioners, compressors, pumps, or the like, that operate to heat or cool the interior of the vehicle (e.g., for operator comfort, to prevent spoilage of cargo, etc.). As another example, an auxiliary or parasitic load can come from one or more blowers 114, such as fans that move air. For example, the blowers can move air to cool components of the vehicle, such as brake resistors that are part of the propulsion system. These resistors can dissipate heat from regenerated current output by traction motors of the propulsion system. The blowers can move air over and/or around the resistors to help cool the resistors. As another example, an auxiliary or parasitic load can include one or more pumps 116 that operate to move fluid. For example, a pump can move coolant through and/or around the engine or other components to cool the engine and/or other components.

The powered system optionally includes a brake 120. Suitable brakes may include a handbrake, friction brake, wheel brake, or the like, that is engaged to slow or stop movement of the powered system. Optionally, the powered system may be able to brake using the traction motors (via regenerative braking) and/or the brake. Alternatively, the brake can be a parking or hand brake that is used to keep a stationary vehicle is a stationary state.

One or more sensors 118 of the drive system sense parameters of the powered system. These parameters can include ambient conditions and/or operational conditions of the powered system. Examples of ambient conditions that can be sensed or measured by the sensors include ambient temperature (e.g., the temperature outside of the vehicle), an internal temperature (e.g., the temperature inside an operator cab, the temperature of one or more components of the powered system, such as a coolant temperature, temperature around braking resistors, engine temperature, etc.), a state of the brake (e.g., whether the brake is engaged or disengaged, whether the wheel brake is locked or unlocked), etc. In one embodiment, the occupancy of the vehicle is a parameter, such as a bus in which a fully occupied bus may be expected to have a higher HVAC load. The operational conditions can include an operational history of the powered system, such as average or typical system speeds during idle, increasing trends in the engine idle speeds, an age of the engine, etc. The sensors can include thermometers, thermocouples, touch sensitive bodies (e.g., piezoelectric bodies, capacitors, etc.).

The controller can receive signals from the sensor(s) that indicate the parameters that are sensed by the sensor(s). The controller can examine the sensed parameters and determine whether the conditions allow for operation of one or more loads of the drive system to be reduced, which can then allow for the engine to operate at an idle speed that is slower than a default, designated, or current idle speed of the engine. The default or designated idle speed can be the speed at which the engine operates at idle when manufactured, when the auxiliary loads operate at a default setting, etc.

In one example, the controller can change (e.g., reduce) the load(s) on the drive system by reducing or changing the settings of the auxiliary components, such as the pump(s), blower(s), heating/cooling system, etc. The controller can send a signal to the heating/cooling system to deactivate the heating/cooling system, to change a set temperature of the heating/cooling system (e.g., the temperature to which the heating/cooling system is instructed to heat or cool the powered system or area), to prevent the set temperature of the heating/cooling system from being changed (e.g., by an operator), etc. This can reduce the demand of the heating/cooling system for current from the alternator or generator to heat or cool the powered system.

As another example, the controller can reduce the drive system load of the vehicle by sending a signal to the blowers to deactivate one or more, or all, of the blowers (so that the blowers that are deactivated no longer operate to move air) and/or to decrease a speed at which the blowers operate to move air. Optionally, the controller can reduce the drive system load by sending a signal to the alternator or generator to reduce a link voltage of the alternator or generator. For example, the controller can direct the alternator or generate to produce less current, which in turn reduces the load on the engine by not requiring the engine to operate at faster idle speeds. In one embodiment, the controller may determine whether the brake (e.g., a handbrake or parking brake) is engaged from the sensor signal(s). If the brake is engaged, then the controller can direct the alternator or generator to reduce the link voltage. This can occur because less current from the alternator or generator may be needed to power the traction motors of the vehicle to prevent movement of the vehicle in case the vehicle begins moving (e.g., down a slight grade in a route), as the brake is engaged.

In one embodiment, after reducing the load on the drive system of the vehicle, the controller can reduce the idle speed of the engine. Decreasing the idle speed of the engine can reduce fuel consumption by the engine. But, responsive to a change in an ambient and/or operational condition, the controller can increase the idle speed of the engine. For example, responsive to a change in the set temperature of the heating/cooling system (as determined from sensor output or operator input), the controller can allow the heating/cooling system to demand more current from the alternator or generator, which increases the load on the engine. This change can occur when a temperature of an area or volume that is heated or cooled by the heating/cooling system warms up above an upper threshold temperature or cools below a lower threshold temperature. This change also can occur when an operator provides input to change the set temperature (e.g., to cause the heating/cooling system to further heat or further cool the area or volume). As another example, the controller can determine (from sensor output) that the temperature of the braking resistors is to hot (e.g., warmer than a threshold temperature), the controller can increase a speed at which the blower(s) operate to cool the braking resistors. In another example, the controller can direct the alternator or generator to increase the link voltage responsive to the brake being released. This may occur to ensure that the propulsion system (e.g., the traction motors) have sufficient current to begin generating propulsion and prevent the vehicle from inadvertently moving down a grade.

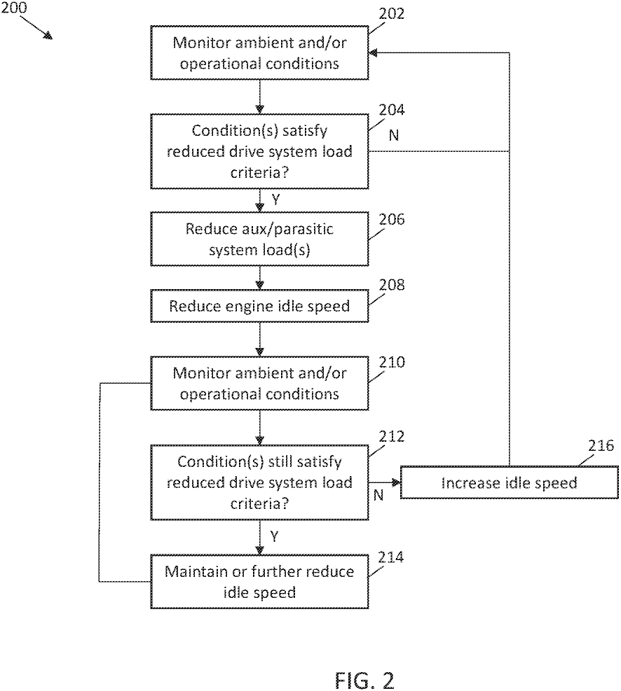

With continued reference to the drive system shown in FIG. 1, FIG. 2 illustrates a flowchart of one example of a method 200 for controlling an electric drive system of a powered system. The method can represent operations performed by the controller, as described herein. At step 202, one or more ambient conditions and/or one or more operational conditions of the powered system are monitored. The conditions can be monitored while the engine of the powered system is not performing primary work of the powered system. With respect to a vehicle as the powered system, this can occur while the vehicle is stationary and the engine is not rotating a shaft to power an alternator or generator to generate current to power traction motors to generate propulsion to keep the vehicle stationary (e.g., when the vehicle is on a hill or other grade). If the engine is operating at a speed that causes the alternator or generator to create electric current that powers the propulsion system to move the vehicle, then the engine is not operating at idle speed.

At step 204, a determination is made as to whether the condition(s) satisfy one or more reduced drive system load criteria. The controller can compare the sensed conditions with one or more thresholds and/or examine the sensed conditions for one or more trends (e.g., an increasing trend or decreasing trend over time) and determine whether the sensed conditions exceed (or fall below) the threshold(s) and/or whether the increasing or decreasing trend is identified. For example, the controller can compare the ambient temperature to a temperature threshold. If the ambient temperature is warmer than the temperature threshold (which may be referred to as a lower temperature threshold), then the controller may determine that the load placed on the drive system by one or more auxiliary or parasitic loads can be reduced. The lower temperature threshold may be a cold temperature below which slower speeds of the engine can result in the engine stopping (e.g., deactivating or no longer operating at any speed). If the ambient temperature is at or above this threshold, the controller can determine that the auxiliary or parasitic loads placed on the drive system can be reduced without the engine stopping. But, if the ambient temperature is below this temperature threshold, then the controller can determine that the auxiliary or parasitic loads placed on the drive system cannot be reduced due to the risk of the engine stopping.

For example, the controller can compare the sensed conditions with one or more thresholds and/or examine the sensed conditions for one or more trends (e.g., an increasing trend or decreasing trend over time) and determine whether the sensed conditions exceed (or fall below) the threshold(s) and/or whether the increasing or decreasing trend is identified. For example, the controller can compare the ambient temperature to a temperature threshold. If the ambient temperature is warmer than the temperature threshold (which may be referred to as a lower temperature threshold), then the controller may determine that the auxiliary or parasitic load(s) can be reduced. The lower temperature threshold may be a cold temperature below which slower speeds of the engine can result in the engine stopping (e.g., deactivating or no longer operating at any speed). If the ambient temperature is at or above this threshold, the controller can determine that the auxiliary or parasitic load(s) can be reduced. But, if the ambient temperature is below this temperature threshold, then the controller can determine that the auxiliary or parasitic load(s) cannot be reduced.

As another example, the controller can compare the sensed internal temperature of the engine or powered system to another temperature threshold to determine whether the auxiliary or parasitic load(s) can be reduced. If the internal temperature is warmer than this temperature threshold, then the controller may determine that the auxiliary loads (e.g., the coolant pump(s), blowers, heating/cooling system, etc.) may not be able to be turned off or reduced to ensure that the powered system or cargo is not damaged. As a result, the controller can determine that the auxiliary or parasitic load(s) can be reduced. But, if the internal temperature is not warmer than this temperature threshold, then the controller may determine that the auxiliary loads may not be able to be turned off or reduced to ensure that the powered system or cargo is not damaged. As a result, the controller can determine that the auxiliary or parasitic load(s) cannot be reduced.

Optionally, the controller can examine the temperature(s) measured at or near the braking resistors. If the temperature(s) is warmer than another temperature threshold associated with the resistors, then the controller can determine that the braking resistors are too hot to reduce blower speed or turn off the blowers. Consequently, the controller may not reduce the auxiliary or parasitic load(s). If the temperature(s) is not warmer than the temperature threshold associated with the resistors, then the controller can determine that the braking resistors are not too hot to reduce blower speed or turn off the blowers. Consequently, the controller may reduce the auxiliary or parasitic load(s).

As another example, the controller can examine the temperature(s) measured in an operator cab. If the temperature(s) is warmer than an upper temperature threshold and/or cooler than a lower temperature threshold, then the controller can determine that the operator cab is too warm or too cool, respectively, to turn off the heating/cooling system. As a result, the controller determines to not reduce the auxiliary or parasitic load(s) . If the temperature(s) is not warmer than the upper temperature threshold and/or is not cooler than the lower temperature threshold, then the controller can determine that the operator cab is within a temperature range that permits the heating/cooling system to be turned off. As a result, the controller determines that the alternator output can decrease and so the auxiliary or parasitic load(s) can be reduced.

The controller can examine the state of the brake as an operational characteristic to determine whether the brake state satisfies the criteria. If the brake state indicates that the brake is engaged, then the controller can determine that the auxiliary or parasitic load(s) can be reduced. But, if the brake state indicates that the brake is disengaged, then the controller can determine that the auxiliary or parasitic load(s) cannot be reduced.

The controller can examine the history of operation of the vehicle to determine whether the auxiliary or parasitic load(s) can be reduced. If this history indicates that the auxiliary or parasitic load(s) has been increasing over time then the controller may determine that the auxiliary or parasitic load(s) can be reduced. Increased auxiliary or parasitic load(s) may be due, at least in part, to the age and/or condition and/or health of components of the system (engine, alternator, harness, power electronics, and the like). If this history indicates that the auxiliary or parasitic load(s) has not been increasing over time, then the controller may determine that the idle speed cannot be reduced. As another example, if this history indicates that prior instances of reducing the auxiliary or parasitic load(s) resulted in the engine stopping, stalling or turning off, then the controller may determine that the auxiliary or parasitic load(s) cannot be reduced. But, if this history indicates that prior instances of reducing the auxiliary or parasitic load(s) did not result in the engine stopping or turning off, then the controller may determine that the auxiliary or parasitic load(s) can be reduced.

As another example, the controller can examine the age of the engine as the operational history. If the engine is less than a threshold age or time (or a number of duty cycles, number of hours, etc. that the engine has been operating in a non-idle state is less than the threshold age or time), then the controller can determine that the auxiliary or parasitic load(s) can be reduced. But, if the engine is not less than the threshold age or time, then the controller can determine that the auxiliary or parasitic load(s) cannot be reduced.

In one embodiment, the controller can compare multiple, different conditions (operational and/or ambient) to criteria to determine whether the auxiliary or parasitic load(s) can be reduced. For example, if all or at least a threshold number or percentage of the conditions meet or satisfy the criteria for reducing the auxiliary or parasitic load(s), then the controller can determine that the auxiliary or parasitic load(s) can be reduced. Otherwise, the controller can determine that the auxiliary or parasitic load(s) cannot be reduced.

If the condition(s) satisfy the reduced drive system load criteria, then the auxiliary or parasitic load placed on the drive system of the vehicle by one or more parasitic or auxiliary loads can be reduced before reducing the idle speed of the engine of the vehicle. As a result, flow of the method 200 can proceed toward step 206. But, if the conditions do not satisfy the reduced drive system load criteria, then the loads placed on the drive system of the vehicle by one or more parasitic or auxiliary loads may not be able to be reduced and/or the idle speed of the engine of the vehicle may not be able to be reduced. As a result, flow of the method 200 can return toward step 202 (for additional monitoring of conditions).

At step 206, the auxiliary or parasitic load(s) are reduced. For example, a setting of one or more auxiliary or parasitic loads can be automatically reduced by the controller.

At step 208, the idle speed is reduced after the parasitic or auxiliary load placed on the drive system is reduced. The controller can change an operating mode of the powered system into a low power mode, which results in the idle speed decreasing. As described herein, the controller can reduce the idle speed by deactivating or reducing operation of one or more auxiliary components of the powered system. For example, the controller can turn off one or more coolant pumps, turn off or reduce the speed of one or more blowers, reduce the voltage link of the alternator or generator, turn off or reduce operation of the heating/cooling system, or the like. This can reduce the amount of fuel consumed by the powered system relative to the powered system operating at a faster idle speed.

At step 210, the ambient and/or operational conditions can continue to be monitored. Subsequent to the idle speed being reduced, the controller can continue receiving output from the sensors to monitor the ambient and/or operational conditions for changes.

At step 212, a determination is made as to whether the ambient and/or operational conditions continue to meet the reduced drive system load criteria for the engine. The operational load placed on the engine may increase due to one or more changing conditions. This load can include parasitic or auxiliary loads, or other loads (e.g., propulsion) placed on the drive system. This increase in the operational load may cause the controller to increase the idle speed to be able to meet the increased auxiliary load, parasitic load, and/or propulsion load. For example, if the ambient temperature cools below the associated temperature threshold, if the internal temperature warms above the associated temperature threshold, if the braking resistor temperature warms above the associated temperature threshold, if the operator cab temperature is no longer within the associated temperature range, if the brake is disengaged, or the like, then the controller may determine that the idle speed may need to be increased. As a result, flow of the method can proceed toward step 216 as the condition(s) no longer indicate that the idle speed can remain at the reduced speed. But, if the condition(s) continue to satisfy the criteria for reduced idle speed, then the idle speed can remain reduced and flow of the method can proceed toward step 214.

Alternatively, the controller may change the operating mode of the powered system from the lower power mode (e.g., reduced idle system speed) responsive to receiving input from an operator. For example, an operator may press a button, actuate a throttle, or the like, to indicate that the vehicle is to exit the lower power mode. The controller can then increase the idle speed.

At step 214, the engine continues to operate at the reduced idle speed. Flow of the method can return toward one or more prior operations (e.g., step 210), or may terminate. At step 216, the idle speed can be increased. For example, the controller can increase the idle speed to a prior idle speed, to the predetermined or designated idle speed, or another idle speed. Flow of the method can return to one or more prior operations (e.g., step 202) or may terminate.

In one embodiment, a method is provided and includes monitoring one or more of an ambient condition or an operational condition of a vehicle system while the vehicle system is stationary and a propulsion system of the vehicle system is operating at an idle speed, determining whether the one or more of the ambient condition or the operational condition satisfy one or more reduced auxiliary or parasitic load criteria, reducing one or more of an auxiliary load or a parasitic load responsive to determining that the one or more ambient condition or the operational condition satisfy the one or more reduced auxiliary or parasitic load criteria, and subsequently reducing the idle speed at which the propulsion system is operating to a slower speed following reducing the one or more of the auxiliary load or the parasitic load.

Optionally, the method can include reducing the idle speed of the propulsion system reduces energy consumption relative to the vehicle system being stationary and the propulsion system of the vehicle system operating at a relatively faster idle speed. The method also may include monitoring one or more of the operational condition of the vehicle system or an operational load placed on the propulsion system of the vehicle system while the vehicle system remains stationary, and increasing the idle speed of the propulsion system responsive to one or more of the operational condition of the vehicle system changing or the operational load placed on the propulsion system increasing.

The idle speed of the propulsion system may be increased responsive to the operational load increasing, the operational load increasing due to operation of an auxiliary load of the vehicle system. The ambient condition that is monitored may be an ambient temperature, the one or more reduced idle speed criteria may include a lower temperature threshold, and the idle speed may be reduced responsive to the ambient temperature being warmer than the lower temperature threshold.

The operational condition of the vehicle system may be monitored and may include one or more of a state of a brake of the vehicle system or an operational history of the vehicle system. The idle speed of the propulsion system may be reduced by changing an operating mode of the vehicle system into a low power mode, where the low power mode of the vehicle system enables one or more of deactivating one or more parasitic loads of the vehicle system while the propulsion system remains activated, reducing an operational speed of the one or more parasitic loads while the propulsion system remains activated, or reducing a link voltage of an alternator of the vehicle system. Propulsion of the vehicle system may be prevented while the vehicle system is operating in the low power mode, further comprising exiting the vehicle system from the low power mode responsive to operator input.

In one embodiment, a vehicle control system includes a controller having one or more processors that may monitor one or both of an ambient condition and an operational condition of a vehicle system while the propulsion system of the vehicle system is operating in a first mode at a first idle speed. The one or more processors may determine whether the one or more of the ambient condition or the operational condition satisfy one or more reduced idle speed criteria. The one or more processors may switch the propulsion system to operate in a second mode at a relatively slower second idle speed responsive to the one or more of the ambient condition or the operational condition satisfying the one or more reduced idle speed criteria.

The propulsion system of the vehicle system may consume less fuel while operating at the idle speed that is reduced relative to the vehicle system being stationary and the propulsion system operates at a faster idle speed. The one or more processors may monitor one or more of the operational condition of the vehicle system or an operational load placed on the propulsion system of the vehicle system while the vehicle system remains stationary. The one or more processors may increase the idle speed of the propulsion system responsive to one or more of the operational condition of the vehicle system changing or the operational load placed on the propulsion system increasing.

The one or more processors may increase the idle speed of the propulsion system responsive to the operational load increasing due to operation of an auxiliary load of the vehicle system. The ambient condition that is monitored may be an ambient temperature, the one or more reduced idle speed criteria include a lower temperature threshold, and the one or more processors may reduce the idle speed responsive to the ambient temperature being warmer than the lower temperature threshold.

The one or more processors may monitor one or more of a state of a brake of the vehicle system or an operational history of the vehicle system as the operational condition of the vehicle system. The one or more processors may reduce the idle speed of the propulsion system by one or more of deactivating one or more parasitic loads of the vehicle system while the propulsion system remains activated, reducing an operational speed of the one or more parasitic loads while the propulsion system remains activated, or reducing a link voltage of an alternator of the vehicle system. The one or more processors may prevent propulsion of the vehicle system while the idle speed of the propulsion system is reduced.

In one embodiment, a method includes monitoring one or more of an ambient condition or an operational condition of a vehicle system while a propulsion system of the vehicle system is operating at an idle speed, determining whether the one or more of the ambient condition or the operational condition satisfy one or more reduced idle speed criteria, reducing the idle speed at which the propulsion system is operating to a slower speed responsive to the one or more of the ambient condition or the operational condition satisfying the one or more reduced idle speed criteria, monitoring one or more of the operational condition of the vehicle system or an operational load placed on the propulsion system of the vehicle system while the vehicle system remains stationary, and increasing the idle speed of the propulsion system responsive to one or more of the operational condition of the vehicle system changing or the operational load placed on the propulsion system increasing.

The idle speed of the propulsion system may be increased responsive to the operational load increasing. The operational load may increase due to operation of an auxiliary load of the vehicle system. The ambient condition that is monitored may be an ambient temperature, the one or more reduced idle speed criteria may include a lower temperature threshold, and the idle speed may be reduced responsive to the ambient temperature being warmer than the lower temperature threshold. The operational condition of the vehicle system that is monitored may include one or more of a state of a brake of the vehicle system or an operational history of the vehicle system. The idle speed of the propulsion system may be reduced by one or more of deactivating one or more parasitic loads of the vehicle system while the propulsion system remains activated, reducing an operational speed of the one or more parasitic loads while the propulsion system remains activated, or reducing a link voltage of an alternator of the vehicle system. Propulsion of the vehicle system may be prevented while the idle speed of the propulsion system is reduced.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
monitoring one or more of an ambient condition or an operational condition of a vehicle system while the vehicle system is stationary and a propulsion system of the vehicle system is operating at an idle speed;
determining whether the one or more of the ambient condition or the operational condition satisfy one or more reduced auxiliary or parasitic load criteria;
reducing one or more of an auxiliary load or a parasitic load responsive to determining that the one or more ambient condition or the operational condition satisfy the one or more reduced auxiliary or parasitic load criteria; and
subsequently reducing the idle speed at which the propulsion system is operating to a slower speed following reducing the one or more of the auxiliary load or the parasitic load.

2. The method of claim 1, wherein reducing the idle speed of the propulsion system reduces energy consumption relative to the vehicle system being stationary and the propulsion system of the vehicle system operating at a relatively faster idle speed.

3. The method of claim 1, further comprising:
monitoring one or more of the operational condition of the vehicle system or an operational load placed on the propulsion system of the vehicle system while the vehicle system remains stationary; and
increasing the idle speed of the propulsion system responsive to one or more of the operational condition of the vehicle system changing or the operational load placed on the propulsion system increasing.

4. The method of claim 3, wherein the idle speed of the propulsion system is increased responsive to the operational load increasing, the operational load increasing due to operation of an auxiliary load of the vehicle system.

5. The method of claim 1, wherein the ambient condition that is monitored is an ambient temperature, the one or more reduced auxiliary or parasitic load criteria include a lower temperature threshold, and the idle speed is reduced responsive to the ambient temperature being warmer than the lower temperature threshold.

6. The method of claim 1, wherein the operational condition of the vehicle system is monitored and includes one or more of a state of a brake of the vehicle system or an operational history of the vehicle system.

7. The method of claim 1, wherein the idle speed of the propulsion system is reduced by changing an operating mode of the vehicle system into a low power mode, wherein the low power mode of the vehicle system enables one or more of deactivating one or more parasitic loads of the vehicle system while the propulsion system remains activated, reducing an operational speed of the one or more parasitic loads while the propulsion system remains activated, or reducing a link voltage of an alternator of the vehicle system.

8. The method of claim 1, wherein propulsion of the vehicle system is prevented while the idle speed is reduced, further comprising increasing the idle speed responsive to operator input.

9. A vehicle control system comprising:
a controller having one or more processors configured to monitor one or both of an ambient condition and an operational condition of a vehicle system while a propulsion system of the vehicle system is operating in a first mode at a first idle speed,
the one or more processors configured to determine whether the one or more of the ambient condition or the operational condition satisfy one or more reduced idle speed criteria, the one or more processors configured to switch the propulsion system to operate in a second mode at a relatively slower second idle speed responsive to the one or more of the ambient condition or the operational condition satisfying the one or more reduced idle speed criteria.

10. The vehicle control system of claim 9, wherein the propulsion system of the vehicle system consumes less fuel while operating at the idle speed that is reduced relative to the vehicle system being stationary and the propulsion system operates at a faster idle speed.

11. The vehicle control system of claim 9, wherein the one or more processors are configured to monitor one or more of the operational condition of the vehicle system or an operational load placed on the propulsion system of the vehicle system while the vehicle system remains stationary, the one or more processors configured to increase the idle speed of the propulsion system responsive to one or more of the operational condition of the vehicle system changing or the operational load placed on the propulsion system increasing.

12. The vehicle control system of claim 11, wherein the one or more processors are configured to increase the idle speed of the propulsion system responsive to the operational load increasing due to operation of an auxiliary load of the vehicle system.

13. The vehicle control system of claim 9, wherein the ambient condition that is monitored is an ambient temperature, the one or more reduced idle speed criteria include a lower temperature threshold, and the one or more processors are configured to reduce the idle speed responsive to the ambient temperature being warmer than the lower temperature threshold.

14. The vehicle control system of claim 9, wherein the one or more processors are configured to monitor one or more of a state of a brake of the vehicle system or an operational history of the vehicle system as the operational condition of the vehicle system.

15. The vehicle control system of claim 9, wherein the one or more processors are configured to reduce the idle speed of the propulsion system by one or more of deactivating one or more parasitic loads of the vehicle system while the propulsion system remains activated, reducing an operational speed of the one or more parasitic loads while the propulsion system remains activated, or reducing a link voltage of an alternator of the vehicle system.

16. The vehicle control system of claim 9, wherein the one or more processors are configured to prevent propulsion of the vehicle system while the idle speed of the propulsion system is reduced.

17. A method comprising:
monitoring one or more of an ambient condition or an operational condition of a vehicle system while a propulsion system of the vehicle system is operating at an idle speed;
determining whether the one or more of the ambient condition or the operational condition satisfy one or more reduced idle speed criteria;
reducing the idle speed at which the propulsion system is operating to a slower speed responsive to the one or more of the ambient condition or the operational condition satisfying the one or more reduced idle speed criteria;
monitoring one or more of the operational condition of the vehicle system or an operational load placed on the propulsion system of the vehicle system while the vehicle system remains stationary; and
increasing the idle speed of the propulsion system responsive to one or more of the operational condition of the vehicle system changing or the operational load placed on the propulsion system increasing.

18. The method of claim 17, wherein the idle speed of the propulsion system is increased responsive to the operational load increasing, the operational load increasing due to operation of an auxiliary load of the vehicle system.

19. The method of claim 17, wherein the ambient condition that is monitored is an ambient temperature, the one or more reduced idle speed criteria include a lower temperature threshold, and the idle speed is reduced responsive to the ambient temperature being warmer than the lower temperature threshold.

20. The method of claim 17, wherein the operational condition of the vehicle system is monitored and includes one or more of a state of a brake of the vehicle system or an operational history of the vehicle system.
